(19) United States
(12) Patent Application Publication
(10) Pub. No.: US 2009/0236166 A1
(43) Pub. Date: Sep. 24, 2009

(54) FRAME STRUCTURE OF AUTOMOTIVE VEHICLE

(75) Inventors: Miho KOWAKI, Hiroshima (JP); Sakayu TERADA, Hiroshima (JP); Yosuke SAWADA, Hiroshima (JP); Isamu KIZAKI, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/389,923

(22) Filed: Feb. 20, 2009

(30) Foreign Application Priority Data
Mar. 24, 2008 (JP) 2008-074843

(51) Int. Cl. B62D 27/04

(52) U.S. Cl. 180/232

(57) ABSTRACT

A centroid of bend portions of a front side frame (frame member) is offset to a specified direction of a vehicle width direction (a bending direction of the front side frame) from a centroid of a different portion from the bend portions. Accordingly, a frame structure which can properly provide the bend portion without causing any improper increase of the number of members can be provided.

### BACKGROUND OF THE INVENTION

The present invention relates to a frame structure of an automotive vehicle, and in particular, relates to the structure for impact absorption.

A frame structure of an automotive vehicle comprises, for example, a dash panel which partitions an engine room from a vehicle compartment, and a frame member which is provided in front of the dash panel so as to extend substantially straight in a vehicle longitudinal direction, a rear end portion of which connects to the dash panel. Herein, there is a concern that the dash panel may retreat in case an impact load is inputted to the frame member in the vehicle longitudinal direction at a vehicle front collision or the like.

An example of a technology to cope with the above-described concern is disclosed in Japanese Patent Laid-Open Publication No. 2003-220977, for example. According this example, at the frame member is provided a bend portion operative to bend in a vehicle width direction when the impact load is inputted to the frame member in the vehicle longitudinal direction. Thereby, the impact load may be absorbed by bending of the frame member, so that the dash panel can be restrained from retreating properly.

Herein, since the bend portion is formed by reinforcing one of the sides of the frame member with a reinforcement member in the above-described example, there is need to provide an additional member of the reinforcement member. This would cause a problem of an increase of the number of members.

### SUMMARY OF THE INVENTION

An object of the present invention is to provide a frame structure which can properly provide the bend portion without causing any improper increase of the number of members.

According to the present invention, there is provided a frame structure of an automotive vehicle, comprising a frame member provided so as to extend substantially straight in a vehicle longitudinal direction, a rear end portion of which connects to a dash panel, and a bend portion provided at the frame member, the bend portion being operative to bend in a specified direction of a vehicle width direction when an impact load is inputted to the frame member in the vehicle longitudinal direction, wherein the frame member has different cross sections in the vehicle longitudinal direction in such a manner that a centroid of the bend portion of the frame member is offset to the specified direction of the vehicle width direction from a centroid of a different portion of the frame member from the bend portion.

According to the present invention, since the centroid of the bend portion of the frame member is offset to the specified direction of the vehicle width direction from the centroid of the different portion of the frame member from the bend portion, the bend portion can be properly provided without causing any improper increase of the number of member. Herein, the centroid is a well-known technical term which is used in the fields of the strength of materials and the like. In case the bend portion of the frame member has offset of the centroid as described above, the input of the impact load may cause a moment which functions so as to rotate the cross section of the bend portion relative to the cross section of the different portion from the bend portion in the plan view. Accordingly, the frame member bends properly.

According to an embodiment of the present invention, the frame member comprising a first member and a second member which are located substantially in the vehicle width direction and have a substantially U-shaped cross section respectively, the first and second members being joined to each other via upper and lower flange portions thereof so as to form a closed cross section of the frame member which extends substantially in the vehicle longitudinal direction, and the first and second members have different shapes of the substantially U-shaped cross section in the vehicle longitudinal direction respectively in such a manner that the upper and lower flange portions thereof at the bend portion of the frame member are located offset to the specified direction of the vehicle width direction from the upper and lower flange portions thereof at the different portion of the frame member from the bend portion. Thereby, the offset of the centroid of the bend portion can be materialized easily.

According to another embodiment of the present invention, a joining line of the upper and lower flange portions of the first and second members at a front portion in front of the bend portion of the frame member and a rear portion in back of the bend portion of the frame member extends substantially straight and obliquely relative to a longitudinal direction of the frame member in a plan view. Thus, the flange portions turn from side to side at the bend portion in the vehicle width direction, so that the position of the bend portion can be specified surely. Thereby, the frame member bends surely at the bend portion.

According to another embodiment of the present invention, a plurality of the bend portions of the frame member which are operative to bend in opposite directions of the vehicle width direction to each other are provided, and the joining line of the upper and lower flange portions of the first and second members at a portion between the bend portions of the frame member extends substantially straight and obliquely relative to the longitudinal direction of the frame member in the plan view. Thereby, the bending of the frame member can be achieved easily compared to a case in which the joining line of the flange portions extends in a curve shape.

According to another embodiment of the present invention, the frame member has a substantially rectangular closed cross section which extends substantially in the vehicle longitudinal direction, and both side faces of the bend portion of the frame member have beads which are recessed toward an opposite side thereof respectively in such a manner that a depth of the recessed bead on a specified side face of the frame member which is located on a side of the specified direction of the vehicle width direction is shallower than that of the recessed bead on an opposite side face of the frame member to the specified side face. Thereby, the offset of the centroid of the bend portion can be materialized easily.

According to another embodiment of the present invention, respective bottom portions of the recessed beads are joined to each other. Thereby, the impact energy can be properly absorbed by friction of the bottom portions of the recessed beads which occurs at the bending of the frame member.

According to another embodiment of the present invention, a vertical length of the recessed bead on the specified side face of the frame member which is located on the side of the specified direction of the vehicle width direction is smaller than that of the recessed bead on the opposite side face of the frame member to the specified side face. Thereby, the offset of the centroid can be achieved properly even in case the width of the frame member is considerably small.

According to another embodiment of the present invention, the frame member has a substantially rectangular closed cross section which extends substantially in the vehicle longitudinal direction, and both side faces of the bend portion of the frame member have projections which project outward respectively in such a manner that a projecting height of the projection on a specified side face of the frame member which is located on a side of the specified direction of the vehicle width direction is greater than that of the projection on an opposite side face of the frame member to the specified side face. Thereby, the offset of the centroid of the bend portion can be materialized easily.

According to another embodiment of the present invention, a vertical length of the projection on the specified side face of the frame member which is located on the side of the specified direction of the vehicle width direction is greater than that of the projection on the opposite side face of the frame member to the specified side face. Thereby, the offset of the centroid of the bend portion can be provided, restraining the height of the projections properly.

According to another embodiment of the present invention, the bend portion of the frame member has a vertical bead on a side face thereof which is opposite to a specified side face thereof which is located on a side of the specified direction of the vehicle width direction, the vertical bead extending vertically and being recessed toward the specified side face of the bend portion. Thereby, the frame member bends surely at the bend portion.

According to another embodiment of the present invention, the vehicle has a suspension damper of a suspension member which is located outside the frame member, and the bend portion is located so as to be offset from the suspension damper in the vehicle longitudinal direction. Thereby, the bend portion which bends is prevented from interfering with the suspension damper, so that the proper bending of the frame member can be achieved.

Other features, aspects, and advantages of the present invention will become apparent from the following description which refers to the accompanying drawings.

### BRIEF DESCRIPTION OF THE DRAWINGS

FIG. 1 is a plan view of a front portion of a vehicle which is equipped with a frame structure of an automotive vehicle according to an embodiment of the present invention.

FIG. 2A is an enlarged plan view of a front side frame on a side which is denoted by an arrow P of FIG. 1, and FIG. 2B is a side view of the front side frame of FIG. 2A when viewed in a direction which is denoted by an arrow L.

FIGS. 3A, 3B, 3C, 3D and 3E are sectional views of the front side frame taken along lines A-A, B-B, C-C, D-D and E-E respectively of FIG. 2B.

FIG. 4 is an explanatory view of an action when an impact load is inputted.

FIG. 5A is an enlarged plan view of a front side frame of a frame structure of an automotive vehicle according to a second embodiment, which corresponds to FIG. 2A, and FIG. 5B is a sectional view taken along line M-M of FIG. 5A.

FIG. 6 is a sectional view of a front side frame of a frame structure of an automotive vehicle according to a third embodiment, which corresponds to FIG. 3C.

FIG. 7A is an enlarged plan view of a front side frame of a frame structure of an automotive vehicle according to a fourth embodiment on the side which is denoted by the arrow P of FIG. 1, and FIG. 7B is a side view of the front side frame of FIG. 7A when viewed in a direction which is denoted by an arrow N

FIGS. 8A, 8B, 8C, 8D and 8E are sectional views of the front side frame taken along lines F-F, G-G, H-H, I-I and J-J respectively of FIG. 7B.

### DETAILED DESCRIPTION OF THE INVENTION

Hereinafter, a frame structure of an automotive vehicle according to preferred embodiments of the present invention will be described.

### Embodiment 1

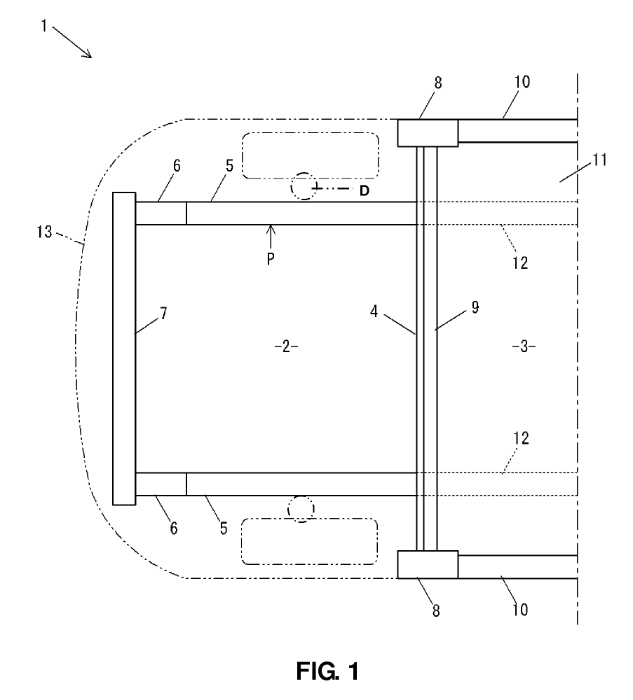

A vehicle body of an automotive vehicle 1 according to the present embodiment comprises, as shown in FIG. 1, a dash panel 4 which partitions an engine room 2 from a vehicle compartment 3, a pair of front side frames 5, 5 which extends straight in a vehicle longitudinal direction in front of the dash panel 4 on both (light and right) sides, rear end portions of which connect to the dash panel 4, a bumper reinforcement 7 which is provided at front end portions of the front side frames 5, 5 via crush cans 6, 6, hinge pillars 8, 8 which are provided at both-side end portions of the dash panel 4 so as to extend vertically and support front end portions of front doors (not illustrated), a dash reinforcement 9 which is provided at a back face of the dash panel 4 so as to interconnect the both-side hinge pillars 8, 8, side sills 10, 10 which connect to the lower ends of the hinge pillars 8, 8 at front end portions thereof and extend rearward, and floor frames 12, 12 which extend in the vehicle longitudinal direction below the floor panel 11 which forms a floor face of the vehicle compartment 3, front end portions of which connect to rear end portions of the front side frames 5, 5.

Herein, when the impact load is inputted to the bumper reinforcement 7 via a bumper face 13 and the like at a vehicle front collision or the like, it is transmitted so as to disperse to members of a vehicle body 4-12 via the crush cans 6, 6 and front side frames 5, 5.

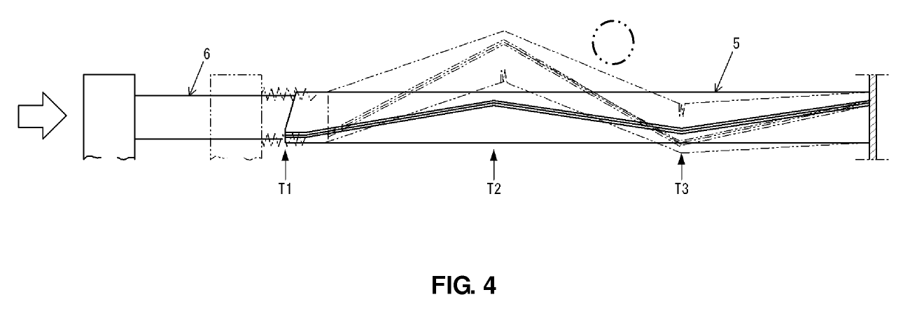

According to the present embodiment, when the impact load is inputted to the vehicle body in the vehicle longitudinal direction, the crush cans 6 crush in an axial direction thereof. The front side frame 5 has a plurality of bend portions T1-T3, which are operative to bend in a vehicle width direction due to the impact load being inputted (see FIG. 4). Hereinafter, the structure will be described.

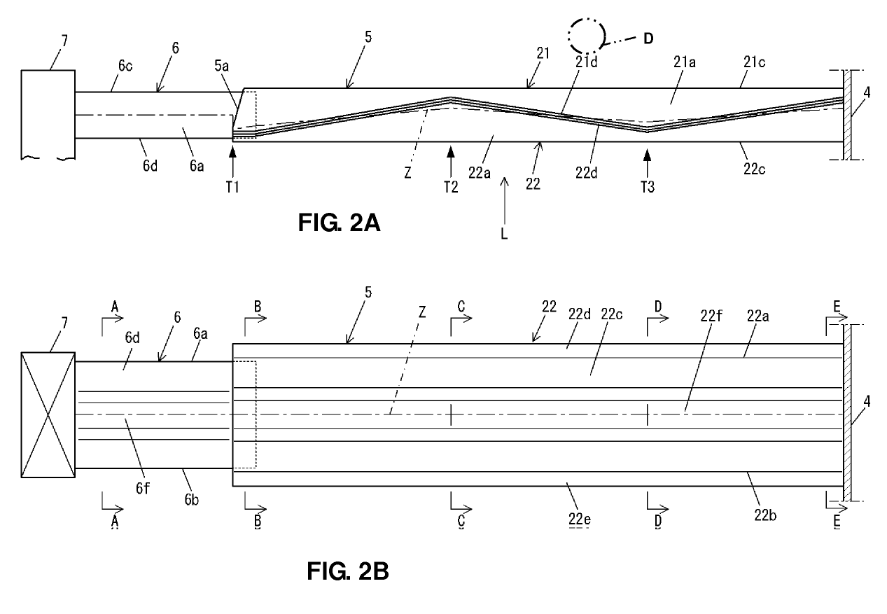

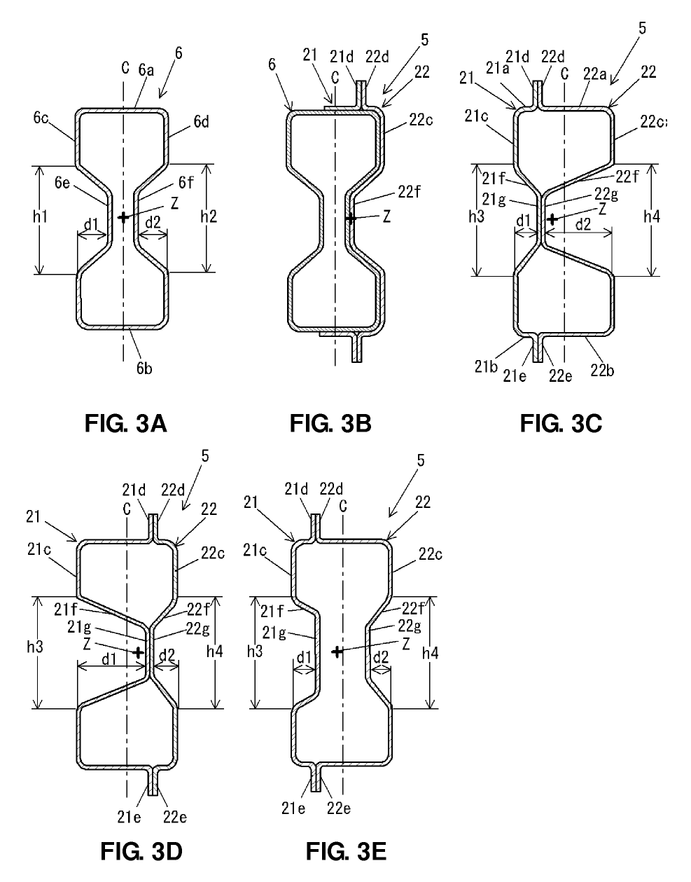

As shown in FIGS. 2A, 2B and 3A, the crush can 6 is made of aluminum material, for example, and it has an upper face portion 6a, a lower face portion 6b, and left and right side face portions 6c, 6d so as to form a rectangular closed cross section which extends substantially straight in the vehicle longitudinal direction. At both side face portions 6c, 6d are formed beads 6e, 6f which are recessed toward their opposite side face portions 6d, 6c respectively and extend in the vehicle longitudinal direction. Herein, the depth d1, d2 and the vertical length h1, h2 of these beads 6e, 6f are the same respectively. Thus, the cross section of the crush can is symmetrical. Further, the thickness and the like of the crush can 6 is configured such that the crush can 6 crushes in an axis direction (a longitudinal direction of the crush can 6) so as to have a compressive deformation in bellows shape when the impact load is inputted in the vehicle longitudinal direction.

Further, the front side frame 5 comprises, as shown in FIGS. 2A, 2B, 3C-3E, a first member 21 which includes an upper face portion 21a, a lower face portion 21b, a side face portion 21c and upper and lower flange portions 21d, 21e so as to have a substantially U-shaped cross section, and a second member 22 which includes an upper face portion 22a, a lower face portion 22b, a side face portion 22c and upper and lower flange portions 22d, 22e so as to have a substantially U-shaped cross section. The upper flange portions 21d, 22d and the lower flange portions 21e, 22e of the first and second members 21, 22 are joined to each other respectively so as to provide the substantially rectangular closed cross section which extends substantially straight in the vehicle longitudinal direction.

Further, at both side face portions 21c, 22c of the first and second members 21, 22 are formed beads 21f, 22f which are recessed toward their opposite side face portions 22c, 21c respectively and extend in the vehicle longitudinal direction. These beads 21f, 22f are provided to strengthen the function of absorption of the impact load by the front side frame 5.

Next, the structure of the bend portions T1-T3 will be described. Apparent from FIGS. 2A, 2B and 3B (a cross section which is located slightly in back of the bend portion T1), the bend portion T1 is provided at a connection portion of the crush can 6 to the front side frame 5, specifically at the front end of the front side frame 5. This bend portion T1 is configured by a difference in the rigidity between the crush can 6 and the front side frame 5. A front end 5a of the front side frame 5 is formed so as to be slant in such a manner that its outward portion is positioned rearward from its inward portion. Thereby, the front side frame 5 bends outward at the bend portion T2.

Meanwhile, the centroid of the bend portions T2, T3 of the front side frame 5 is offset to a specified direction of the vehicle width direction from the centroid of the different portion of the front side frame 5 from the bend portions T2, T3.

That is, as apparent from FIGS. 2A, 2B and 3C, the upper flange portions 21d, 22d and the lower flange portions 21e, 22e at the bend portion T2 are located offset to the above-described specified direction of the vehicle width direction, i.e., outward of the vehicle, from the upper and lower flange portions 21d, 22d, 21e, 22e at the different portion from the bend portion T2. Further, while a vertical length h3 of the bead 21f is the same as a vertical length h4 of the bead 22f (which is the same as other portions in the longitudinal direction), a depth d1 of the outside bead 21f is shallower than a depth d2 of the inside bead 22f. Thus, the centroid Z of the bend portion T2 is offset toward the side of the side face portion 21c of the first member 21 from a middle (center) position C between the side face portions 21c, 22c of the front side frame 5. Also, as apparent from FIG. 2A, the centroid Z of the bend portion T2 is offset outward of the vehicle from the centroid Z of the different portion from the bend portion T2. Herein, as shown in FIGS. 1, 2A and 4, the vehicle has a suspension damper D of a suspension member which is located outside the front side frame 5, and the bend portion T2 is located so as to be offset from the suspension damper D in the vehicle longitudinal direction. Thereby, the bend portion T2 which bends is prevented from interfering with the suspension damper D.

Further, as apparent from FIGS. 2A, 2B and 3D, the upper flange portions 21d, 22d and the lower flange portions 21e, 22e at the bend portion T3 are located offset to the above-described specified direction of the vehicle width direction, i.e., inward of the vehicle because the bending direction of the bend portion T3 is opposite to that of the above-described bend portion T2, from the upper and lower flange portions 21d, 22d, 21e, 22e at the different portion from the bend portion T3. Further, a depth d2 of the inside bead 22f is shallower than a depth d1 of the outside bead 21f. Thus, the centroid Z of the bend portion T3 is offset toward the side of the side face portion 22c of the second member 22 from the middle (center) position C between the side face portions 21c, 22c of the front side frame 5. That is, the centroid Z of the bend portion T3 is offset inward of the vehicle from the centroid Z of the different portion from the bend portion T3.

Further, as apparent from FIGS. 2A, 2B and 3E, the upper flange portions 21d, 22d and the lower flange portions 21e, 22e at a portion of the front side frame 5 which is positioned near its connection portion to the dash panel 4 are located similarly to the bend portion T2. A depth d1 of the outside bead 21f is substantially the same as a depth d2 of the inside bead 22f. Herein, the front side frame 5 does not bend at this portion near the connection portion to the dash panel.

Further, as apparent from FIG. 2A, a joining line of the upper flange portions 21d, 22d and the lower flange portions 21e, 22e at a portion of the front side frame 5 between the bend portions T2, T3 extends substantially straight and obliquely relative to a longitudinal direction of the front side frame 5 in the plan view.

The beads 21f, 22f have bottom portions 21g, 22g respectively which are formed at the side face portions 21c, 22c, and these bottom portions 21g, 22g are joined to each other at the bend portions T2, T3.

Hereinafter, the operation of the present embodiment will be described.

When the impact load is inputted to the vehicle body in the vehicle longitudinal direction, the crush can 6 crushes so as to deform in the axis direction and the front side frame 5 bends in the vehicle width direction at the bend portions T1-T3 as shown by broken lines in FIG. 4.

Herein, since the centroid Z of the bend portions T2, T3 of the front side frame 5 is offset in the vehicle width direction from the centroid Z of the different portion of the front side frame 5 from the bend portions T2, T3, the bend portions T2, T3 can be properly provided without causing any improper increase of the number of member.

Also, the above-described offset of the centroid of the bend portions T2, T3 can be materialized easily by the structure in which the upper flange portions 21d, 22d and the lower flange portions 21e, 22e at the bend portions T2, T3 are located offset to the above-described specified direction of the vehicle width direction from the upper flange portions 21d, 22d and the lower flange portions 21e, 22e at the different portion of the front side frame 5 from the bend portions T2, T3.

Further, since the respective joining lines of the upper flange portions 21d, 22d and the lower flange portions 21e, 22e at the front portion in front of the bend portions T2, T3 and the rear portion in back of the bend portions T2, T3 extend substantially straight and obliquely relative to the longitudinal direction of the front side frame 5 in the plan view, these flange portions turn from side to side at the bend portions T2, T3 in the vehicle width direction, so that the position of the bend portions T2, T3 can be specified surely. Thereby, the front side frame 5 bends surely at the bend portions T2, T3.

Also, since the plural bend portions T2, T3 operative to bend in the opposite directions of the vehicle width direction to each other are provided, and the joining line of the upper flange portions 21d, 22d and the lower flange portions 21e, 22e at the portion between the bend portions T2, T3 extends substantially straight and obliquely relative to the longitudinal direction of the front side frame 5 in the plan view, the bending of the front side frame 5 can be achieved easily compared to a case in which the joining line of the flange portions extends in a curve shape.

Further, the offset of the centroid of the bend portions T2, T3 can be materialized easily by the structure in which the depth of the beads 21f, 22f is different from each other.

Also, since the bottom portions 21g, 22g of the recessed beads 21f, 22f are joined to each other, the impact energy can be properly absorbed by friction of the bottom portions 21g, 22g which occurs at the bending of the front side frame 5. Further, the deformation of the side face portions 21c, 22c of the beads 21f, 22f can be controlled properly.

While both the offset joining line provision of the upper flange portions 21d, 22d and the lower flange portions 21e, 22e and the different depth d1, d2 of the beads 21f, 22f are provided to make the offset provision of the centroid Z in the above-described embodiment, either one of these may be applied for the offset of the centroid Z. In this case, the strength of the front side frame 5 may be considered for this application.

### Embodiment 2

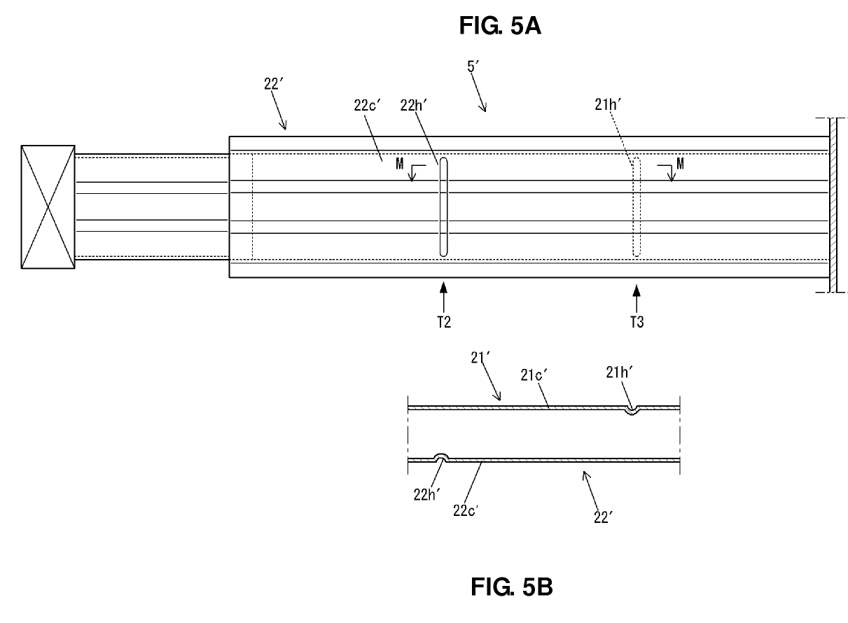

In a second embodiment, as shown in FIG. 5, the bend portions T2, T3 of a first member 21′ and a second member 22′ which forms a front side frame 5′ has vertical beads 21h′, 22h′ on their side face portions 21c′, 22c′. The vertical beads 21h′, 22h′ extend vertically and are recessed in the bending direction of the bend portions T2, T3, respectively. Thereby, the front side frame 5′ bends surely at the bend portions T2, T3.

### Embodiment 3

Next, a third embodiment will be described.

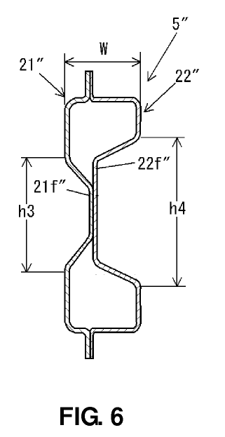

In the third embodiment, a front side frame 5″ has a narrower width W than the first and second embodiments as shown in FIG. 6. This is because this frame 5″ may be properly applied to a relatively narrow layout space for the frame 5″ at the front portion of the vehicle.

Herein, a vertical length h3 of a bead 21f″ of a first member 21″ which forms a front side frame 5″ is not equal to a vertical length h4 of a bead 22f″ of a second member 22″. Thus, the centroid Z can be positioned to be offset more toward the first member 21″ compared to the case in which the both vertical lengths are equal to each other. Thereby, the offset of the centroid Z can be achieved properly even in case the width W of the front side frame 5 is considerably small.

### Embodiment 4

A fourth embodiment will be described.

In the fourth embodiment, as shown in 7A, 7B, 8A-8E, a crush can 106 has an upper face portion 106a, a lower face portion 106b and side face portions 106c, 106d so as to form a substantially rectangular closed cross section which extends substantially straight in the vehicle longitudinal direction. The both side face portions 106c, 106d have projections 106e, 106f which project outward respectively. Heights d1, d2 and vertical lengths h1, h2 of the projections 106e, 106f are equal to each other, respectively, such that the cross section of the crush can 106 is symmetrical. Further, the thickness and the like of the crush can 106 is configured such that the crush can 10 crushes in the axis direction (longitudinal direction of the crush can 106) so as to have the compressive deformation in bellows shape when the impact load is inputted in the vehicle longitudinal direction.

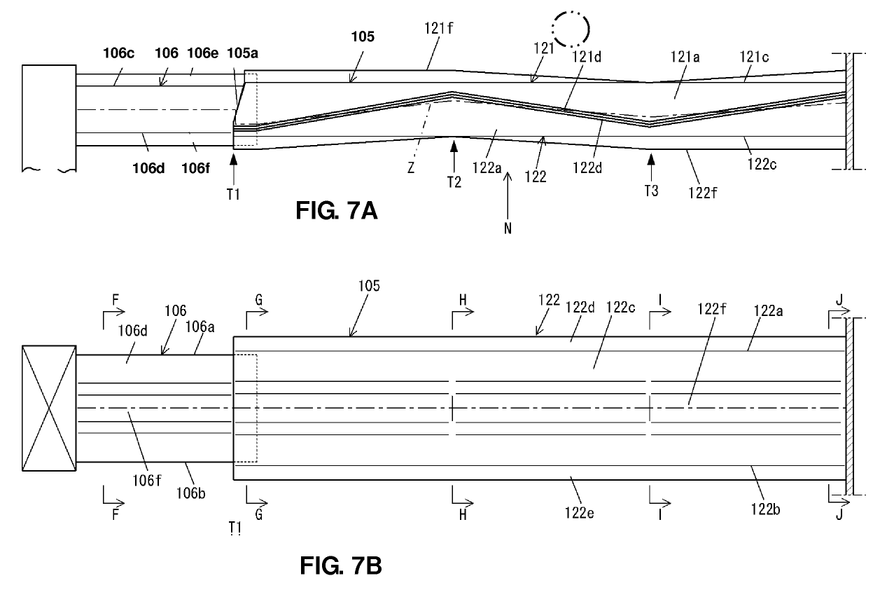

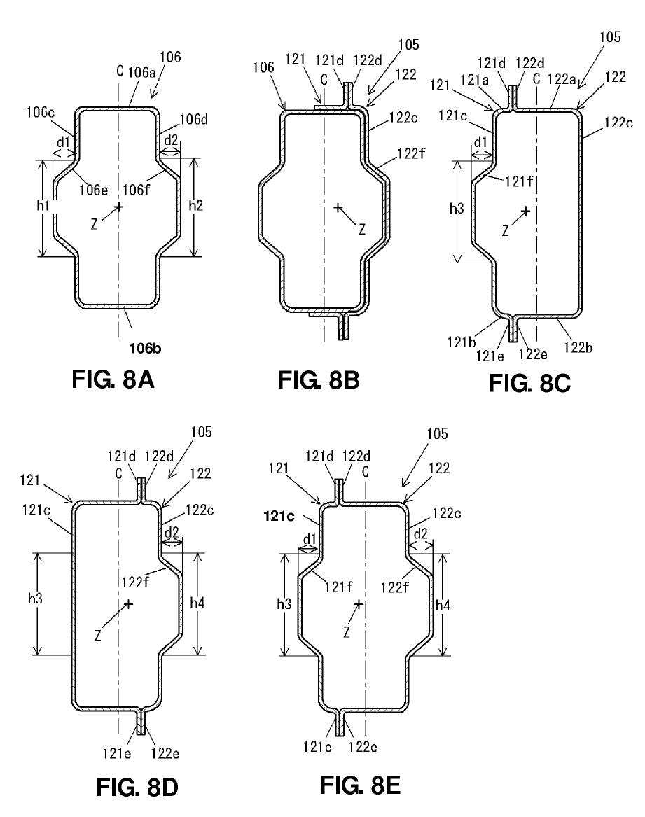

Further, the front side frame 105 comprises, as shown in FIGS. 7A, 7B, 8C-8E, a first member 121 which includes an upper face portion 121a, a lower face portion 121b, a side face portion 121c and upper and lower flange portions 121d, 121e so as to have a substantially U-shaped cross section, and a second member 122 which includes an upper face portion 122a, a lower face portion 122b, a side face portion 122c and upper and lower flange portions 122d, 122e so as to have a substantially U-shaped cross section. The upper flange portions 121d, 122d and the lower flange portions 121e, 122e of the first and second members 121, 122 are joined to each other respectively so as to provide the substantially rectangular closed cross section which extends substantially straight in the vehicle longitudinal direction.

Further, at both side face portions 121c, 122c of the first and second members 121, 122 are formed projections 121f, 122f which project toward the opposite sides to the side face portions 122c, 121c respectively and extend in the vehicle longitudinal direction. These projections 121f, 122f are provided to strengthen the function of absorption of the impact load by the front side frame 105.

Next, the structure of the bend portions T1-T3 will be described. Apparent from FIGS. 7A, 7B and 8B (a cross section which is located slightly in back of the bend portion T1), the bend portion T1 is provided at a connection portion of the crush can 106 to the front side frame 105, specifically at the front end of the front side frame 105. This bend portion T1 is configured by a difference in the rigidity between the crush can 106 and the front side frame 105. A front end 105a of the front side frame 105 is formed so as to be slant in such a manner that its outward portion is positioned rearward from its inward portion. Thereby, the front side frame 105 bends outward at the bend portion T2.

That is, as apparent from FIGS. 7A, 7B and 8C, the upper flange portions 121d, 122d and the lower flange portions 121e, 122e at the bend portion T2 are located offset to the above-described specified direction of the vehicle width direction, i.e., outward of the vehicle, from the upper and lower flange portions 121d, 122d, 121e, 122e at the different portion from the bend portion T2. Further, a height d1 of the outside projection 121f is greater than a height d2 of the inside projection 122f (the height d2 is zero at this portion). Thus, the centroid Z of the bend portion T2 is offset outward of the vehicle from the centroid Z of the different portion from the bend portion T2.

Further, as apparent from FIGS. 7A, 7B and 8D, the upper flange portions 121d, 122d and the lower flange portions 121e, 122e at the bend portion T3 are located offset to the above-described specified direction of the vehicle width direction, i.e., inward of the vehicle from the upper and lower flange portions 121d, 122d, 121e, 122e at the different portion from the bend portion T3 (similar to the above-described first embodiment regarding the flange portions). Further, the height d2 of the inside projection 122f is greater than the height d1 of the outside projection 121f (the height d1 is zero at this portion). Thus, the centroid Z of the bend portion T3 is offset inward of the vehicle from the centroid Z of the different portion from the bend portion T3.

Further, as apparent from FIGS. 7A, 7B and 8E, the upper flange portions 121d, 122d and the lower flange portions 121e, 122e at a portion of the front side frame 105 which is positioned near its connection portion to the dash panel 4 are located similarly to the bend portion T2. A height d1 of the outside projection 121f is substantially the same as a height d2 of the inside projection 122f. Herein, the front side frame 105 does not bend at this portion near the connection portion to the dash panel.

According to the present embodiment, the offset of the centroid Z of the bend portions T2, T3 can be materialized easily by the structure in which the height of the projections 121f, 122f is different from each other.

Herein, the vertical length may be set to be different from each other like the above-described third embodiment. Thereby, the centroid may be offset properly, restraining the projection height.

While the front side frame is configured to bend in the vehicle width direction in the above-described embodiments, the present invention is applicable to any case in which the front side frame bends vertically or in any angle direction between the lateral direction and the vertical direction. Further, while either the recessed bead or the projection are formed at the both side faces of the front side frame in the above-described embodiments, the combination of these may be applied in such a manner that the projection is formed at the bending-direction side and the recessed bead is formed at the other side.

Any other modifications and improvements may be applied in the scope of a sprit of the present invention.

What is claimed is:

1. A frame structure of an automotive vehicle, comprising:
a frame member provided so as to extend substantially straight in a vehicle longitudinal direction, a rear end portion of which connects to a dash panel; and
a bend portion provided at the frame member, the bend portion being operative to bend in a specified direction of a vehicle width direction when an impact load is inputted to the frame member in the vehicle longitudinal direction,
wherein said frame member has different cross sections in the vehicle longitudinal direction in such a manner that a centroid of said bend portion of the frame member is offset to said specified direction of the vehicle width direction from a centroid of a different portion of the frame member from the bend portion.

2. The frame structure of an automotive vehicle of claim 1, wherein said frame member comprising a first member and a second member which are located substantially in the vehicle width direction and have a substantially U-shaped cross section respectively, the first and second members being joined to each other via upper and lower flange portions thereof so as to form a closed cross section of the frame member which extends substantially in the vehicle longitudinal direction, and said first and second members have different shapes of the substantially U-shaped cross section in the vehicle longitudinal direction respectively in such a manner that the upper and lower flange portions thereof at said bend portion of the frame member are located offset to said specified direction of the vehicle width direction from the upper and lower flange portions thereof at the different portion of the frame member from the bend portion.

3. The frame structure of an automotive vehicle of claim 2, wherein a joining line of said upper and lower flange portions of the first and second members at a front portion in front of said bend portion of the frame member and a rear portion in back of said bend portion of the frame member extends substantially straight and obliquely relative to a longitudinal direction of the frame member in a plan view.

4. The frame structure of an automotive vehicle of claim 3, wherein a plurality of said bend portions of the frame member which are operative to bend in opposite directions of the vehicle width direction to each other are provided, and the joining line of the upper and lower flange portions of the first and second members at a portion between the bend portions of the frame member extends substantially straight and obliquely relative to the longitudinal direction of the frame member in the plan view.

5. The frame structure of an automotive vehicle of claim 1, wherein said frame member has a substantially rectangular closed cross section which extends substantially in the vehicle longitudinal direction, and both side faces of said bend portion of the frame member have beads which are recessed toward an opposite side thereof respectively in such a manner that a depth of the recessed bead on a specified side face of the frame member which is located on a side of said specified direction of the vehicle width direction is shallower than that of the recessed bead on an opposite side face of the frame member to said specified side face.

6. The frame structure of an automotive vehicle of claim 5, wherein respective bottom portions of said recessed beads are joined to each other.

7. The frame structure of an automotive vehicle of claim 5, wherein a vertical length of the recessed bead on the specified side face of the frame member which is located on the side of said specified direction of the vehicle width direction is smaller than that of the recessed bead on the opposite side face of the frame member to the specified side face.

8. The frame structure of an automotive vehicle of claim 1, wherein said frame member has a substantially rectangular closed cross section which extends substantially in the vehicle longitudinal direction, and both side faces of said bend portion of the frame member have projections which project outward respectively in such a manner that a projecting height of the projection on a specified side face of the frame member which is located on a side of said specified direction of the vehicle width direction is greater than that of the projection on an opposite side face of the frame member to said specified side face.

9. The frame structure of an automotive vehicle of claim 8, wherein a vertical length of the projection on the specified side face of the frame member which is located on the side of said specified direction of the vehicle width direction is greater than that of the projection on the opposite side face of the frame member to the specified side face.

10. The frame structure of an automotive vehicle of claim 1, wherein said bend portion of the frame member has a vertical bead on a side face thereof which is opposite to a specified side face thereof which is located on a side of said specified direction of the vehicle width direction, the vertical bead extending vertically and being recessed toward said specified side face of the bend portion.

11. The frame structure of an automotive vehicle of claim 1, wherein the vehicle has a suspension damper of a suspension member which is located outside said frame member, and said bend portion is located so as to be offset from the suspension damper in the vehicle longitudinal direction.
